(19) United States
(12) Patent Application Publication
(10) Pub. No.: US 2014/0309835 A1
(43) Pub. Date: Oct. 16, 2014

(54) PATH FINDING DEVICE, SELF-PROPELLED WORKING APPARATUS, AND NON-TRANSITORY COMPUTER READABLE MEDIUM

(71) Applicant: FUJI XEROX CO., LTD., Tokyo (JP)

(72) Inventor: Kunitoshi YAMAMOTO, Kanagawa (JP)

(73) Assignee: FUJI XEROX CO., LTD., Tokyo (JP)

(21) Appl. No.: 14/132,154

(22) Filed: Dec. 18, 2013

(30) Foreign Application Priority Data
Apr. 16, 2013 (JP) 2013-086127

(51) Int. Cl. G05D 1/02

(52) U.S. Cl. CPC G05D 1/0212
USPC 701/25; 701/400; 701/527

(57) ABSTRACT

A path finding device includes a search unit, a calculation unit, and a selection unit. The search unit finds paths to reach a goal point from a start point while detouring around a stationary obstacle. The calculation unit calculates, for each of the found paths, an encounter probability that is a probability of encountering a non-stationary obstacle using previously accumulated non-stationary obstacle information. The selection unit selects a path with a lowest encounter probability among the found paths.

### CROSS-REFERENCE TO RELATED APPLICATIONS

This application is based on and claims priority under 35 USC 119 from Japanese Patent Application No. 2013-086127 filed Apr. 16, 2013.

### BACKGROUND

(i) Technical Field

The present invention relates to a path finding device, a self-propelled working apparatus, and a non-transitory computer readable medium.

(ii) Related Art

Technologies for searching for routes from the start to the goal and selecting the shortest route have been developed and proposed.

In recent years, there have been an increasing number of companies that adopt “free address” (also called non-territorial or hot-desk) offices in which workers do not have particular desks or office spaces and share all the work spaces, which leads to an increase in office productivity. In addition, cloud-based mobile working has become increasingly popular. Such technologies allow workers to work even in a public space, such as a cafe. In this situation, guaranteeing security is a challenging issue. To this end, an image forming apparatus such as a printer, which is of the self-propelled type, is made to move to a position near the user and to execute the desired print job. The self-propelled image forming apparatus desirably has a function to determine a path from a start point to a goal point where the user is located and to move in accordance with the determined path.

It is common to search for multiple paths that the self-propelled image forming apparatus may take from the start point to the goal point and to select the path with the shortest distance from among the multiple paths as an optimum path. In a certain environment such as a cafe, people move around, as they desire, for various purposes and may presumably move on the selected path. Therefore, people may become non-stationary or moving obstacles for the self-propelled image forming apparatus.

### SUMMARY

According to an aspect of the invention, there is provided a path finding device including a search unit, a calculation unit, and a selection unit. The search unit finds paths to reach a goal point from a start point while detouring around a stationary obstacle. The calculation unit calculates, for each of the found paths, an encounter probability that is a probability of encountering a non-stationary obstacle using previously accumulated non-stationary obstacle information. The selection unit selects a path with a lowest encounter probability among the found paths.

### BRIEF DESCRIPTION OF THE DRAWINGS

Exemplary embodiments of the present invention will be described in detail based on the following figures, wherein:

FIG. 1 illustrates a path finding mechanism for a self-propelled working apparatus according to an exemplary embodiment;

FIG. 2 illustrates the path finding mechanism for the self-propelled working apparatus according to the exemplary embodiment;

FIG. 3 illustrates a movable area of the self-propelled working apparatus according to the exemplary embodiment;

FIG. 4 illustrates a map of non-stationary obstacles according to the exemplary embodiment;

FIG. 5 illustrates the path finding mechanism for the self-propelled working apparatus according to the exemplary embodiment;

FIG. 6 illustrates the superimposition of the map upon the area according to the exemplary embodiment;

FIG. 7 illustrates the path finding mechanism for the self-propelled working apparatus when a non-stationary obstacle appears according to the exemplary embodiment;

FIG. 8 is a block diagram of the self-propelled working apparatus according to the exemplary embodiment;

FIG. 9 illustrates non-stationary obstacle information according to the exemplary embodiment;

FIG. 10 illustrates map information according to the exemplary embodiment;

FIG. 11 illustrates accumulated obstacle information according to the exemplary embodiment;

FIG. 12 is a flowchart illustrating a process according to the exemplary embodiment;

FIG. 13 is a flowchart illustrating a process according to another exemplary embodiment;

FIG. 14 illustrates a path rerouting mechanism according to the other exemplary embodiment;

FIG. 15 illustrates the path rerouting mechanism according to the other exemplary embodiment;

FIG. 16 illustrates the path rerouting mechanism according to the other exemplary embodiment; and

FIG. 17 illustrates a warning mechanism according to still another exemplary embodiment.

### DETAILED DESCRIPTION

A self-propelled working apparatus according to an exemplary embodiment of the present invention will be described with reference to the drawings in the context of a self-propelled image forming apparatus configured to determine a path in a cafe and move to the goal along the path. However, the present invention is not limited to the illustrated example.

### Basic Principles of Exemplary Embodiment

First, the basic principles on a path finding mechanism according to this exemplary embodiment will be described.

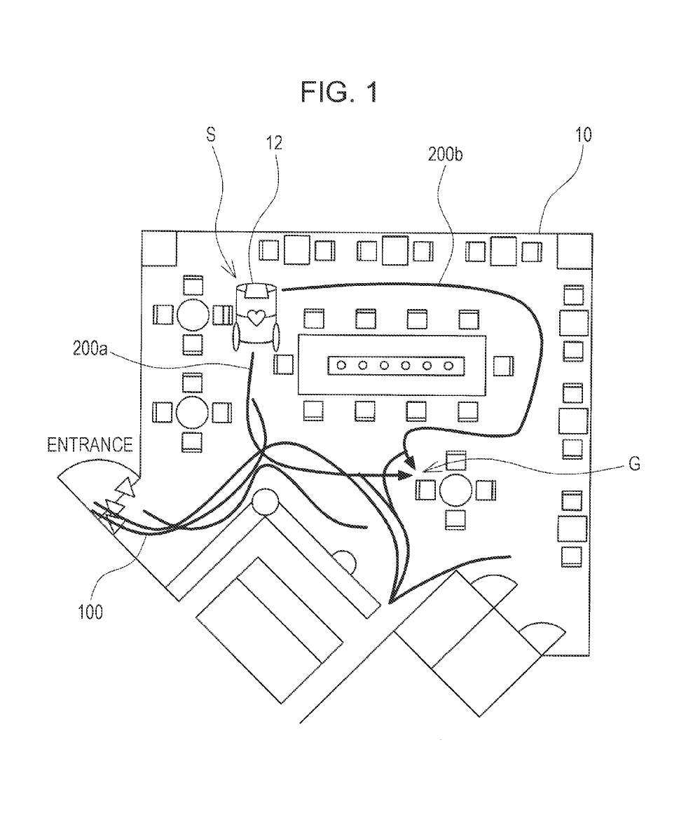

FIG. 1 is a plan view of an example of a cafe 10. The cafe 10 includes various facilities and equipment such as tables, chairs, a checkout counter, a dish return area, and a food delivery counter. In the cafe 10, people move around for various purposes such as paying bills, receiving items, and returning dishes. In FIG. 1, solid lines 100 represent movement trajectories, or lines of movement, of people in the cafe 10. In one possible typical example of the lines of movement 100, a person enters from the entrance of the cafe 10, pays a fee at the checkout counter, receives a coffee, sits on a chair, returns a dish, and exits through the entrance.

It is now assumed that a user enters the cafe 10, sits on a chair at a goal point G, operates a mobile device to perform a certain operation, and requests a self-propelled image forming apparatus 12 waiting at a start point S to execute a print job. In this case, the self-propelled image forming apparatus 12 finds paths from the start point S to the goal point G, determines a path, moves to the goal point G along the determined path, and executes the print job at the goal point G. Stationary and non-stationary obstacles exist from the start point S to the goal point G. The term “stationary obstacles”, as used herein, refers to obstacles that are stationary for a certain amount of time or more, such as walls, posts, tables, and foliage plants. The term “non-stationary obstacles”, as used herein, is used to include customers, customers' belongings, and obstacles temporarily used by the customers and movable, as desired, by the customers, such as persons, chairs, bags, and umbrellas. The non-stationary obstacles may include moving and movable obstacles, and will be hereinafter also referred to as “moving obstacles” or “movable obstacles”.

The self-propelled image forming apparatus 12 detects the positions of stationary obstacles, and finds a path that will not interfere with the stationary obstacles across an area in which the self-propelled image forming apparatus 12 is movable within the cafe 10. An existing path finding method may be used. It is assumed that, as a result of path finding, two paths that the self-propelled image forming apparatus 12 may take from the start point S to the goal point G are found. In FIG. 1, the two paths are represented by a path 200a and a path 200b.

Since the path 200a has a shorter path length than the path 200b, the self-propelled image forming apparatus 12 will select the path 200a among the paths 200a and 200b in accordance with the algorithm of selecting the path with the shortest distance.

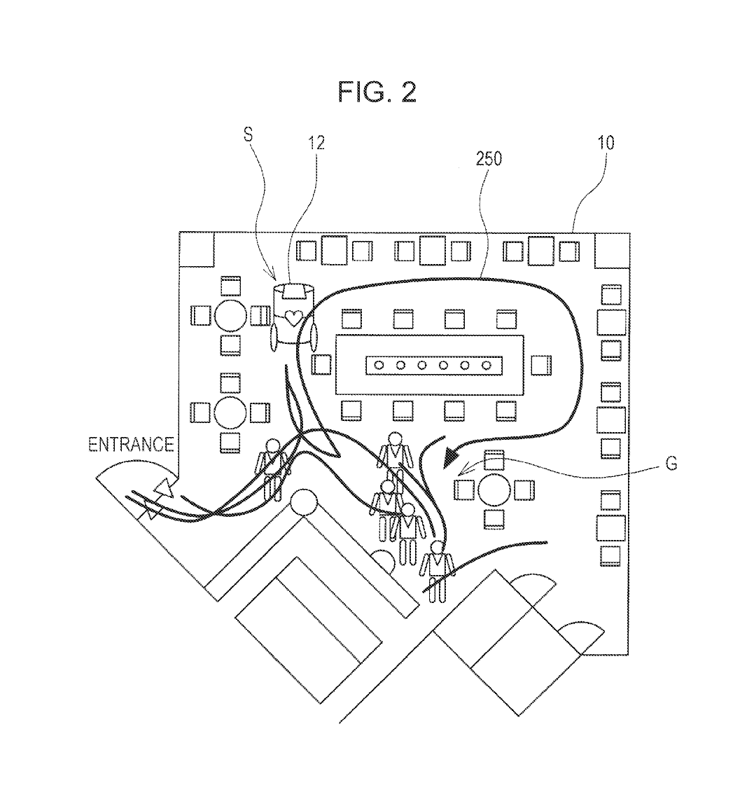

However, since the path 200a interferes with the lines of movement 100 of non-stationary obstacles, which are indicated by the solid lines, as illustrated in FIG. 2, for example, customers in the cafe 10 might become moving obstacles on the path 200a as a result of their movement. In this case, as illustrated in FIG. 2, the self-propelled image forming apparatus 12 starts moving along the path 200a. Upon encountering a moving or movable obstacle such as a person, the self-propelled image forming apparatus 12 retraces the path along which it has come, goes back to the start point S, selects the path 200b as an alternative route, and then moves along the path 200b. Consequently, the self-propelled image forming apparatus 12 moves along a path 250 including the paths 200a and 200b, which may take a wasteful amount of time.

In this exemplary embodiment, if there are multiple paths that the self-propelled image forming apparatus 12 may take to reach the goal as in FIG. 1, the self-propelled image forming apparatus 12 performs control to reduce the priority of a path that will interfere with the lines of movement 100 of the moving obstacles so as not to encounter moving or movable obstacles while it is moving to prevent obstacle avoidance processing. In FIG. 1, since the path 200a will interfere with the lines of movement 100 of the moving obstacles, the priority of the path 200a is reduced. In contrast, the path 200b will not interfere with the lines of movement 100 of the moving obstacles although it is not the shortest path length, and thus the priority thereof is not reduced. Accordingly, the self-propelled image forming apparatus 12 selects the path 200b, which is not the shortest path, as an optimum path, and starts to move along the path 200b.

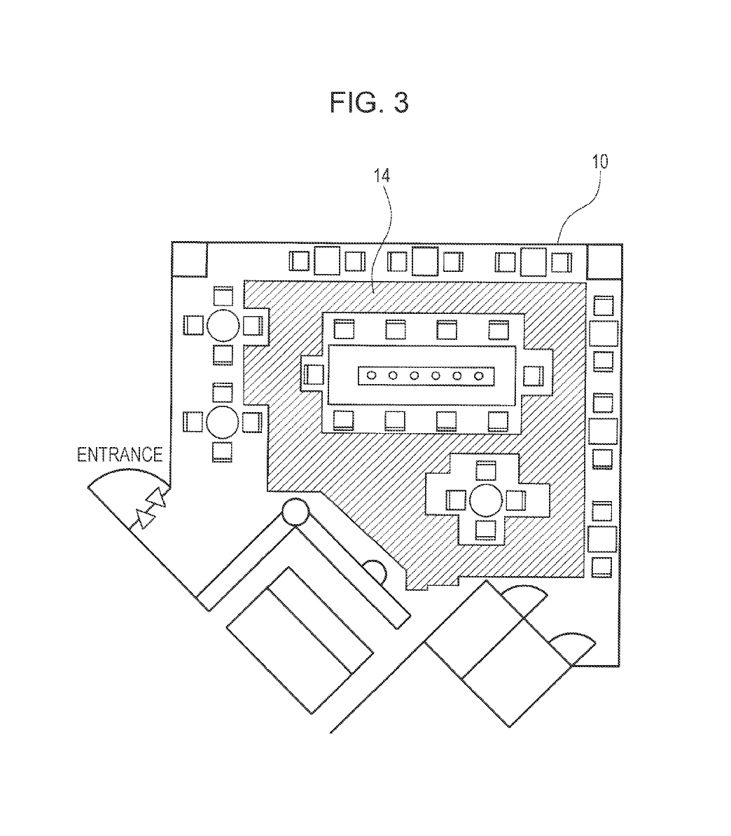

FIG. 3 illustrates a map possessed by the self-propelled image forming apparatus 12. The self-propelled image forming apparatus 12 stores a map which shows the inside of the cafe 10 and also shows a movable area 14 in which the self-propelled image forming apparatus 12 is movable. The map shows no stationary obstacles. A computational processing device of the self-propelled image forming apparatus 12 finds paths to reach the goal point on the basis of the map. The coordinates of the movable area 14 are not fixed, and may be automatically corrected (by adding or deleting an area) using the detection of a stationary obstacle during the movement of the self-propelled image forming apparatus 12 as a trigger.

In addition to the map, the self-propelled image forming apparatus 12 also stores previously accumulated obstacle information (e.g., coordinates, day of week, time of day, and obstacle types). The self-propelled image forming apparatus 12 stores previous obstacle information by collecting items all the time using a sensor included in the self-propelled image forming apparatus 12 or sensors (such as cameras or ultrasonic waves) installed at certain positions in the cafe 10.

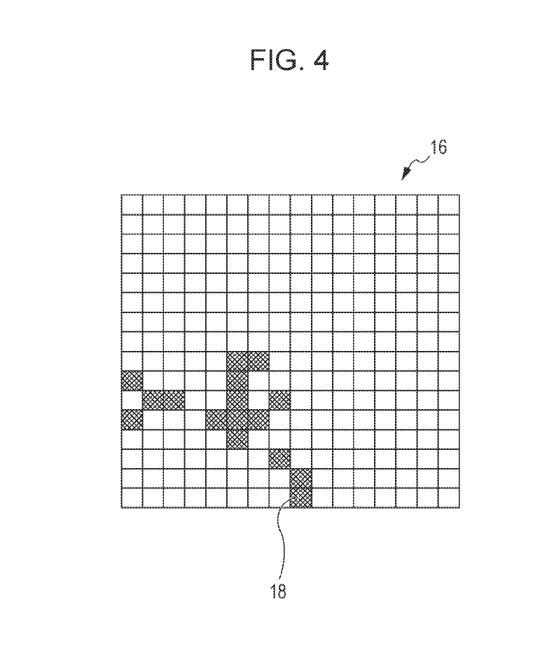

FIG. 4 illustrates an example of a map 16 including the previously accumulated obstacle information which has been collected. The map 16 is a map of a target area which is divided into grids, and previous obstacle information is collected for each grid. In FIG. 4, grids 18 where obstacles have been detected are indicated by shading. As described above, obstacle information for each grid includes coordinates, day of week, time of day, and obstacle types.

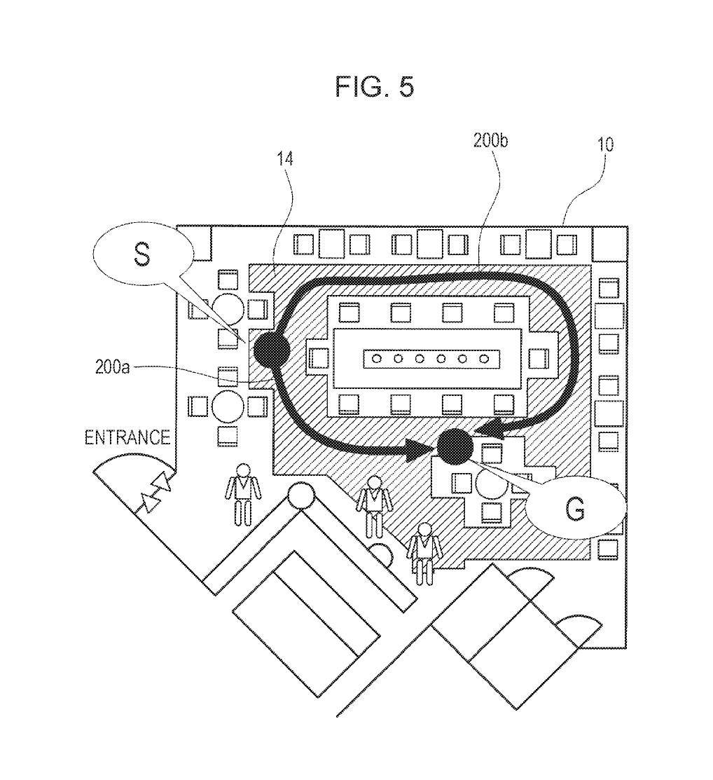

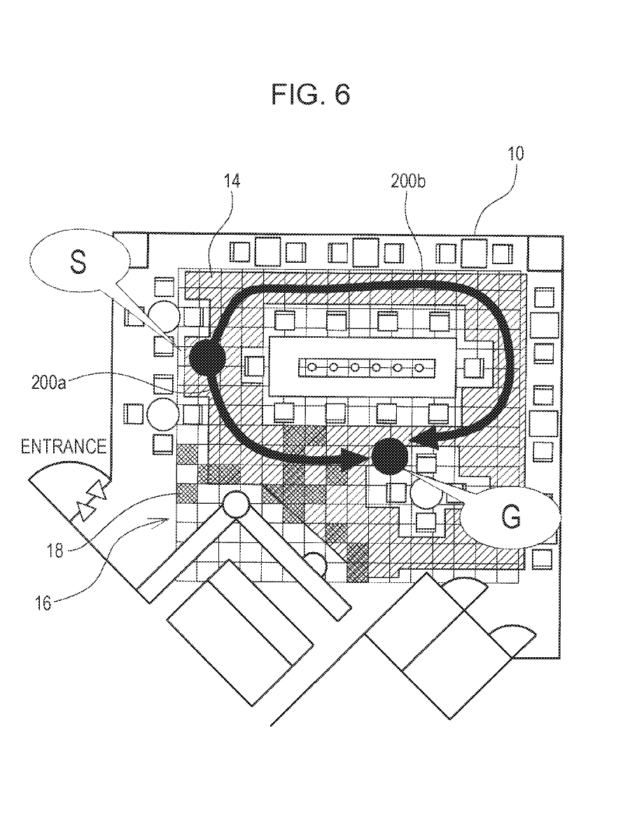

FIG. 5 illustrates paths that the self-propelled image forming apparatus 12 may take to reach the goal point G. The paths are obtained by searching for each path from the start point S to the goal point G using the map of the movable area 14. The path 200a and the path 200b are obtained as paths to reach the goal point G. FIG. 6 illustrates a map in which the map 16 illustrated in FIG. 4 including the obstacle information is overlaid on the illustration of FIG. 5. Comparing the paths 200a and 200b illustrated in FIG. 6 with the map 16 illustrated in FIG. 4 will show that the path 200a includes the grids 18 where obstacles have been detected. That is, if the self-propelled image forming apparatus 12 moves along the path 200a, it will encounter obstacles and will perform some obstacle avoidance processing. In contrast, the path 200b does not include the grids 18 where obstacles have been detected. Thus, if the self-propelled image forming apparatus 12 moves along the path 200b, it will not encounter obstacles and will not perform any obstacle avoidance processing.

Accordingly, the self-propelled image forming apparatus 12 reduces the priority of the path 200a in the map illustrated in FIG. 6, and selects the path 200b as an optimum path to reach the goal point G.

In this manner, according to this exemplary embodiment, a path that might interfere with non-stationary obstacles is not selected, and a path that might not interfere with non-stationary obstacles is selected even though it is not the shortest path length. Since whether or not a path will interfere with non-stationary obstacles is based on previous obstacle information, new non-stationary obstacle, which is not included in the previous obstacle information, may presumably appear on a selected path.

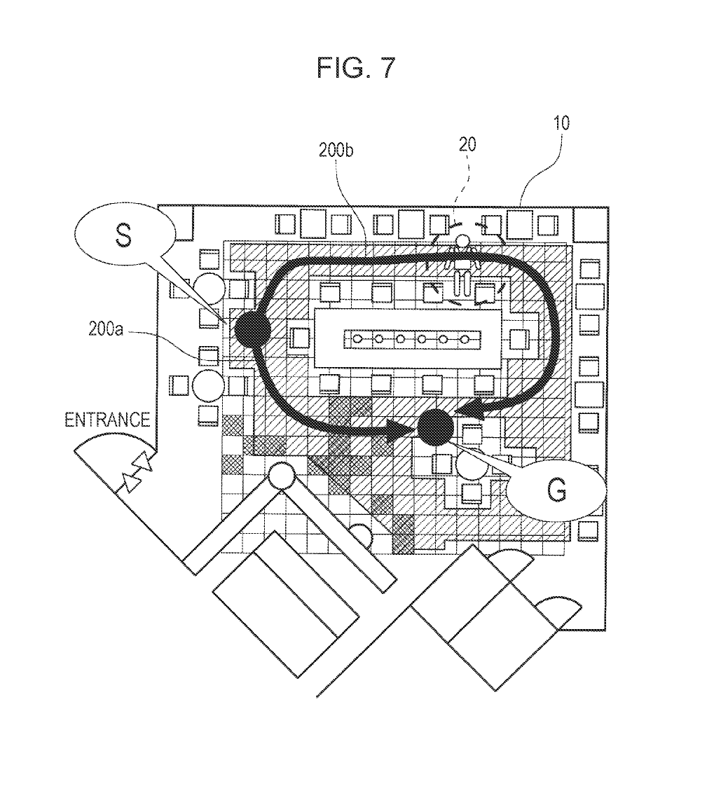

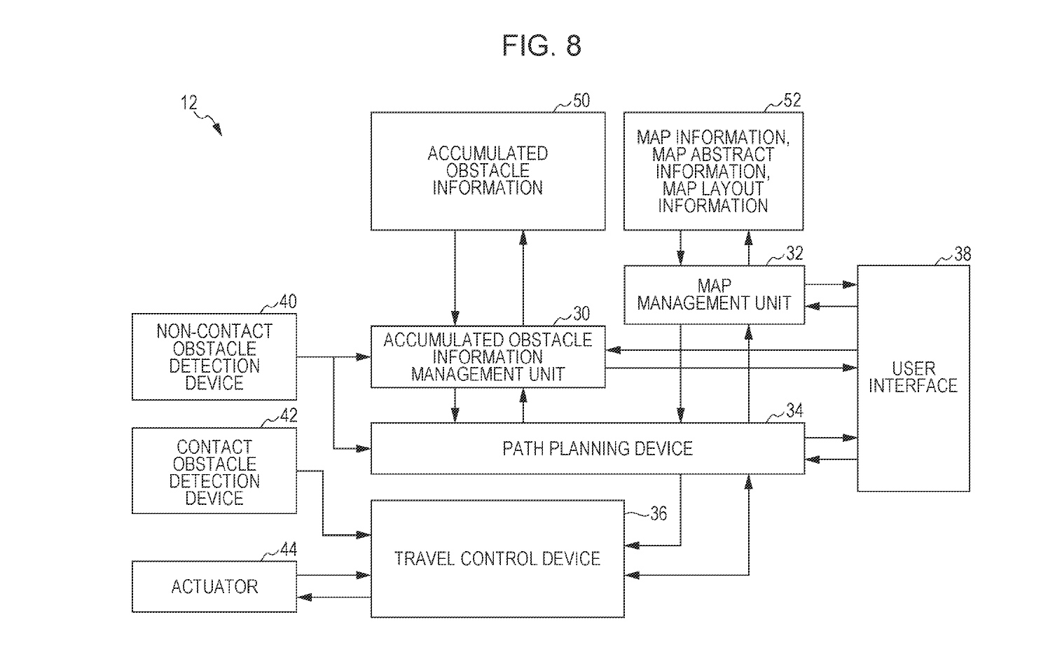

FIG. 7 illustrates an example in the above situation. The self-propelled image forming apparatus 12 reduces the priority of the path 200a among the paths 200a and 200b that the self-propelled image forming apparatus 12 may take from the start point S to the goal point G across the movable area 14 because the path 200a will interfere with non-stationary obstacles on the basis of previously accumulated obstacle information 50 which has been obtained for the path 200a (see FIG. 8), and selects the path 200b as an optimum path. However, while the self-propelled image forming apparatus 12 is moving to the goal point G, a new moving obstacle 20 such as a person may appear on the path 200b and may be detected by a sensor included in the self-propelled image forming apparatus 12 or a sensor installed at a certain position in the cafe 10.

In this case, because of the moving obstacle 20 on the path 200b, the path 200a and the path 200b are under the same condition in terms of the presence of non-stationary obstacles. The self-propelled image forming apparatus 12 selects the path 200a rather than the path 200b as an optimum path because the accumulated obstacle information 50, which is previous obstacle information, indicates that the probability of interference with obstacles is relatively high, whereas, because of the presence of the moving obstacle 20 on the path 200b, the path 200b will interfere with the moving obstacle 20 with certainty. In other words, the path 200a has a lower probability of interfering with non-stationary obstacles than the path 200b.

If a moving obstacle 20 on the path 200b is detected, the path 200a may not necessarily be selected as an optimum path. An optimum path may be selected in accordance with the results of quantitative evaluation of the probability of obstruction of the moving obstacle 20.

More specifically, if a moving obstacle 20 on the path 200b is detected, the self-propelled image forming apparatus 12 determines a distance from the start point S to the moving obstacle 20, and evaluates the probability of obstruction of the moving obstacle 20 in accordance with the distance. For example, the following calculation is used for evaluation.

Probability of obstruction=1/distance

The above equation indicates that a shorter distance would result in a higher degree of obstruction, or a higher probability of interference with the moving obstacle 20. Since the self-propelled image forming apparatus 12 moves at a certain speed or less, a large distance to the moving obstacle 20 would result in a large amount of time being required to reach the position of the moving obstacle 20. Within this amount of time, the moving obstacle 20 may move off the path 200b. The self-propelled image forming apparatus 12 weighs the probability of obstruction calculated from the obstacle information on the path 200a against the probability of obstruction calculated from the distance to the moving obstacle 20. If the distance to the moving obstacle 20 is short and the probability of obstruction of the moving obstacle 20 is high, the path 200a is selected. Conversely, if the distance to the moving obstacle 20 is long and the probability of obstruction of the moving obstacle 20 is low, the path 200b is selected.

The processing described above may be simplified as follows: The self-propelled image forming apparatus 12 stores a threshold distance L. The self-propelled image forming apparatus 12 selects the path 200a if the distance to the moving obstacle 20 is less than or equal to the threshold distance L, and selects the path 200b if the distance to the moving obstacle 20 exceeds the threshold distance L.

### Configuration of Exemplary Embodiment

A specific configuration of this exemplary embodiment will now be described.

FIG. 8 is a block diagram of the self-propelled image forming apparatus 12 according to this exemplary embodiment. The self-propelled image forming apparatus 12 includes an accumulated obstacle information management unit 30, a map management unit 32, a path planning device 34, a travel control device 36, a user interface 38, a non-contact obstacle detection device 40, a contact obstacle detection device 42, and an actuator 44.

The accumulated obstacle information management unit 30 stores and manages previously accumulated obstacle information 50. The accumulated obstacle information management unit 30 supplies the accumulated obstacle information 50 to the path planning device 34.

The map management unit 32 stores and manages map information 52. The map information 52 includes map abstract information and map layout information. The map abstract information is information for identifying maps having similar layouts as an identical map. The map layout information is map information on stationary obstacles. The map management unit 32 supplies the map information 52 to the path planning device 34.

The path planning device 34 finds a path from the start point S to the goal point G on the basis of the map information 52 supplied from the map management unit 32 and the accumulated obstacle information 50 supplied from the accumulated obstacle information management unit 30. The path planning device 34 supplies the found path to the travel control device 36.

The travel control device 36 outputs a driving signal to the actuator 44 so that the self-propelled image forming apparatus 12 may move along the path found by the path planning device 34.

The actuator 44 includes a travel motor, a brake, a steering motor, and so forth, and is driven in accordance with the driving signal supplied from the travel control device 36 to cause the self-propelled image forming apparatus 12 to move.

The non-contact obstacle detection device 40 may be a camera, an infrared sensor, an ultrasonic wave sensor, or the like configured to detect a non-stationary obstacle, and supplies the detected non-stationary obstacle to the accumulated obstacle information management unit 30 and the path planning device 34. The detected non-stationary obstacle is stored in the accumulated obstacle information management unit 30 as a piece of accumulated obstacle information 50. The degree of obstruction or the like of the detected non-stationary obstacle is further evaluated by the path planning device 34, and is used for path finding.

The contact obstacle detection device 42 detects an obstacle while the self-propelled image forming apparatus 12 is moving, and supplies the detected obstacle to the travel control device 36.

The user interface 38 is configured to notify the user or the customers in the cafe 10 of the state of the self-propelled image forming apparatus 12. The user interface 38 sends a message to cause the customers to move off the path by, for example, turning on a light of the self-propelled image forming apparatus 12 during movement.

The self-propelled image forming apparatus 12 further includes a device for receiving image data, a device for printing image data, a device for outputting a printed image, and so forth. These devices are common in an image forming apparatus, and a description thereof is thus omitted.

In FIG. 8, the self-propelled image forming apparatus 12 includes the accumulated obstacle information management unit 30, and is configured to store and manage the accumulated obstacle information 50. Alternatively, a server in the cafe 10 may store and manage the accumulated obstacle information 50, and supply the accumulated obstacle information 50 to the path planning device 34 of the self-propelled image forming apparatus 12, if necessary. The same applies to the map management unit 32.

The accumulated obstacle information management unit 30 and the map management unit 32 may be each formed of a memory. The path planning device 34 and the travel control device 36 may be each formed of a computer, more specifically, a processor such as a central processing unit (CPU) or a microprocessor unit (MPU).

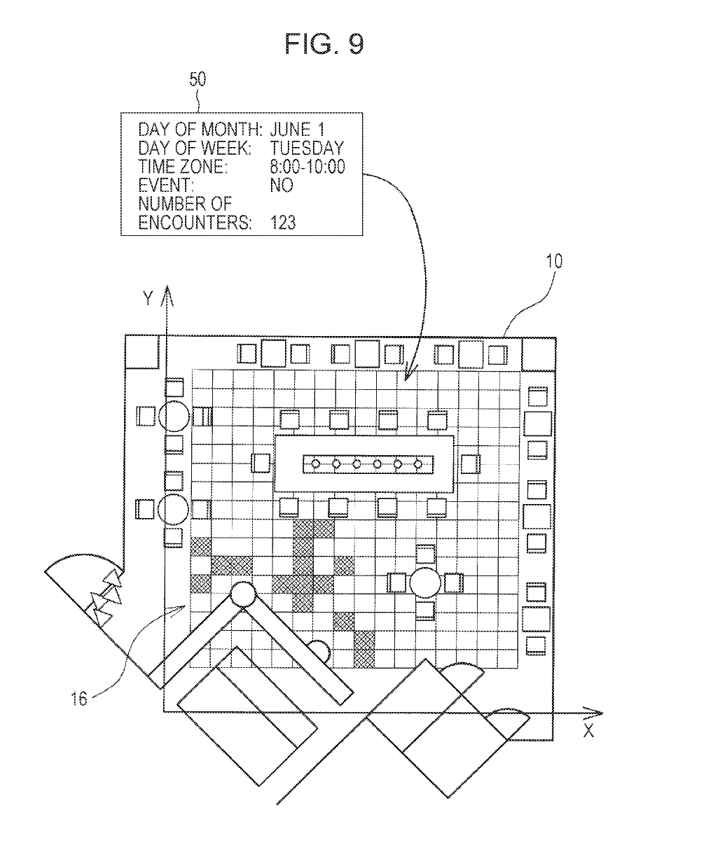

FIG. 9 illustrates an example of the accumulated obstacle information 50. The accumulated obstacle information 50 is managed in units of grids of the map 16. The accumulated obstacle information 50 includes day of month, day of week, time zone, event, and the number of encounters. An event is registered when a specific event takes place in the cafe 10. The number of encounters refers to the total number of previous encounters. The accumulated obstacle information 50 illustrated in FIG. 9 indicates that, in a certain grid, no specific event took place on June 1, Tuesday, at 8:00 to 10:00, and non-stationary obstacles appeared 123 times in total.

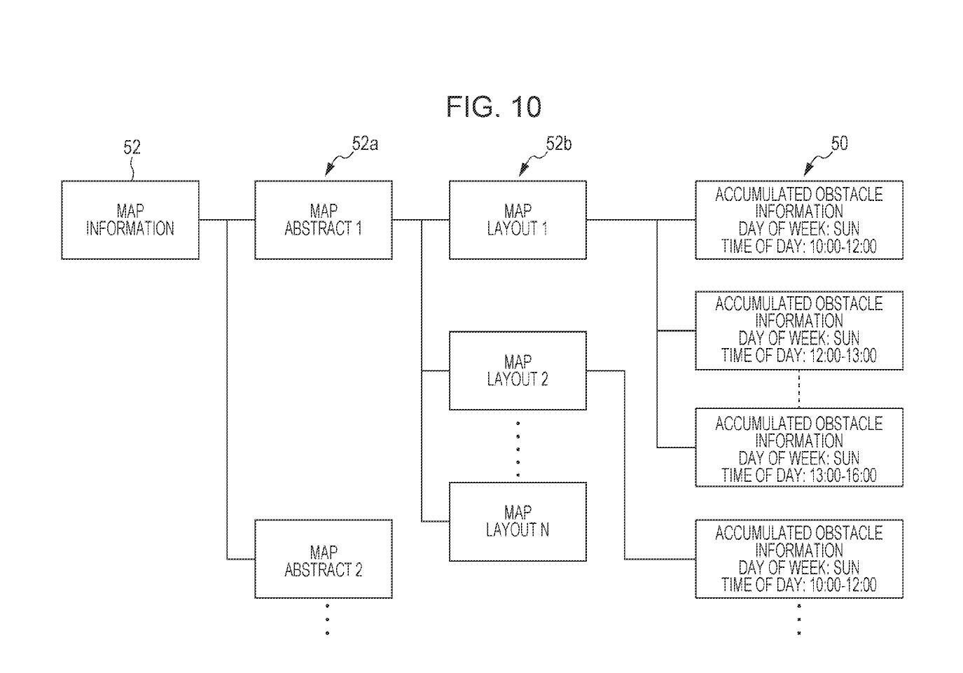

FIG. 10 illustrates relationships between the map information 52 and the accumulated obstacle information 50. The map information 52 includes map abstracts 52a, and each of the map abstracts 52a includes map layouts 52b. Each of the map layouts 52b is a map of the layout of stationary obstacles, and different map layouts 52b represent different layouts of stationary obstacles. For example, there are some patterns having different layouts of stationary obstacles in a cafe A. In this case, these patterns are classified into map layout 1, map layout 2, and so forth. Map layouts for the same cafe are similar to each other even though they are somewhat different. Each of the map abstracts 52a is a map including a group of such similar map layouts. In some cases, the same cafe may have greatly different layouts of stationary obstacles. In these cases, such different layouts are registered in different map abstracts 52a. Accumulated obstacle information 50 is registered for each map layout 52b. That is, multiple pieces of accumulated obstacle information 50 are registered for the map layout 1, and multiple pieces of accumulated obstacle information 50 are registered for the map layout 2. Referring to FIG. 9, a specific map layout indicating a layout of stationary obstacles in the cafe 10 is given, and accumulated obstacle information 50 is registered for each grid in the map layout.

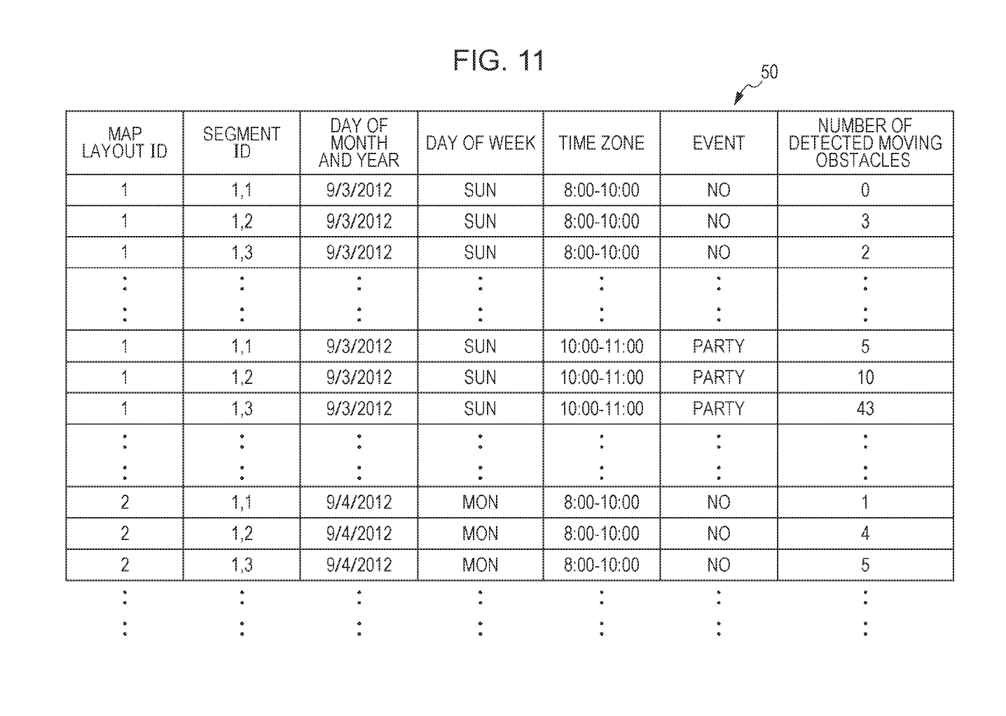

FIG. 11 illustrates the details of the accumulated obstacle information 50. The accumulated obstacle information 50 specifies a map layout ID, a segment ID, day of month and year, day of week, time zone, event, and the number of detected moving obstacles. In FIG. 11, the segment ID is an ID identifying a grid in the map layout. For example, the segment ID (1, 1) represents a grid at the x-y two-dimensional orthogonal coordinates (x, y)=(1, 1).

In FIG. 11, for the grid with segment ID=(1, 1), the event “party” is specified on Sep. 3, 2012 at 10:00 to 11:00. This means that a party was held at this time of day on this day of week, and that the number of detected moving obstacles was five. The path planning device 34 finds a path using the accumulated obstacle information 50. If an event is taking place in this grid, the path planning device 34 utilizes the number of detected moving obstacles in the accumulated obstacle information 50, namely, five, in the path finding process. If no event is taking place in this grid, the path planning device 34 does not utilize the number of detected moving obstacles in the accumulated obstacle information 50, namely, five, because conditions are different.

### Path Finding Process of Exemplary Embodiment

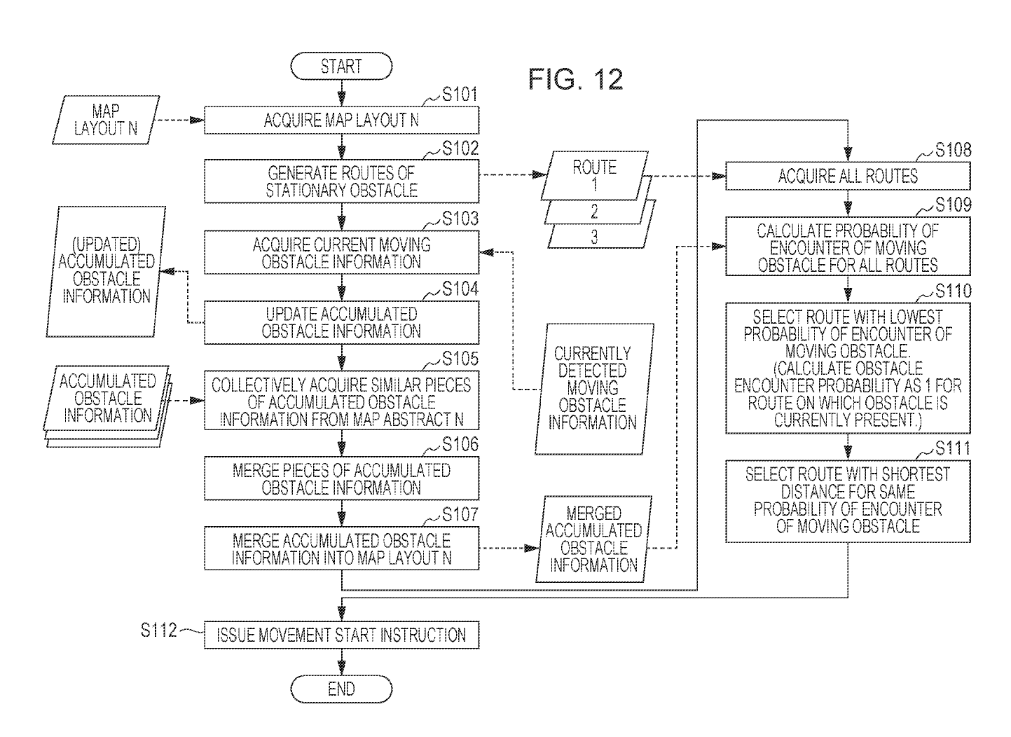

FIG. 12 is a flowchart illustrating a path finding (or path planning) process according to this exemplary embodiment. The path finding process is executed by the path planning device 34, and is implemented by reading a program stored in a program memory such as a read-only memory (ROM) or any other medium and executing the program. The program may be initially stored in a program memory as firmware, or may be installed via a network. Alternatively, the program may be recorded on a portable recording medium such as a compact disc (CD) or a digital versatile disc (DVD), and may be installed from the portable recording medium.

First, the path planning device 34 accesses the map management unit 32, and acquires the corresponding map layout N (S101). The corresponding map layout N is a map layout that matches the layout in the cafe 10 across which the self-propelled image forming apparatus 12 is to move.

Then, the path planning device 34 develops routes that will not interfere with stationary obstacles using the map layout N (S102). Although the accumulated obstacle information 50 is included in each grid in the map layout N, the path planning device 34 develops routes without taking into account the accumulated obstacle information 50. The developed routes are represented as route 1, route 2, route 3, and so forth. The developed routes are temporarily stored in a working memory.

Then, the path planning device 34 acquires accumulated non-stationary obstacle information at the present time (S103). That is, a non-stationary obstacle on a route is detected using the non-contact obstacle detection device 40, and detected non-stationary obstacle information is input. Alternatively, a non-stationary obstacle is detected using a sensor installed at a certain position in the cafe 10, and detected non-stationary obstacle information is input. The obstacle information includes the position of the non-stationary obstacle, that is, a grid. Upon acquiring the current non-stationary obstacle information, the path planning device 34 updates the accumulated obstacle information 50 stored in the map management unit 32 using the acquired information (S104). Specifically, in the accumulated obstacle information 50 illustrated in FIG. 11, an item for the corresponding segment ID (grid ID) is updated using the newly acquired non-stationary obstacle information. For example, the number of detected moving obstacles for the segment ID=(1, 1) is updated from 2 to 3, the number of detected moving obstacles for the segment ID=(1, 4) is updated from 0 to 1, and the like.

Then, the path planning device 34 accesses the map management unit 32, and collectively acquires similar pieces of accumulated obstacle information from the map abstract N (S105). For example, if the map layout N acquired in S101 is included in map abstract 1 and the map abstract 1 includes the map layout N and map layouts 1 and 2, all the pieces of accumulated obstacle information 50 included in the map layouts 1 and 2 are acquired (see FIG. 10).

Then, the path planning device 34 merges all the acquired pieces of accumulated non-stationary obstacle information (S106), and further merges the resulting accumulated non-stationary obstacle information into the map layout N (S107). That is, all the pieces of accumulated non-stationary obstacle information are added to the corresponding grid in the map layout N.

Then, the path planning device 34 reads and acquires all the routes developed in S102 from the working memory (S108), and calculates the probabilities of encounter of a moving obstacle for all the routes (S109). Specifically, the path planning device 34 computes the encounter probability for a certain route by reading the accumulated obstacle information 50 on all the grids on the route and weighting each of the items of day of week, time zone, event, and the number of encounters. For example, a coefficient “1” is set if there is a match for the day of week, and a coefficient “0.5” is set if there is no match for the day of week. Further, a coefficient “1” is set if there is a match for the time zone, and a coefficient “0.5” is set if there is no match for the time zone. A coefficient “1” is set if there is a match for the event, and a coefficient “0.5” is set if there is no match for the event. These coefficients are multiplied, and the number of encounters is evaluated using the resulting coefficient to compute the probability. In this exemplary embodiment, the probability is defined as an index indicating the degree of likelihood, and may not necessarily be a value between 0 and 1. Any index capable of quantitative evaluation may be used. For example, if the number of encounters at the grid (x, y) on the route is 5 and there is a match for the day of week, time zone, and event, the probability is given by

Probability=1×1×1×5=5.

If there is no match for any of the day of week, time zone, and event, the probability is given by

Probability=0.5×0.5×0.5×5=0.625.

The probabilities for all the grids on the route are computed in a similar manner, and the highest probability is used as the encounter probability for the route. The above calculation is merely an example, and any other calculation method may be used. Instead of using the highest probability as the encounter probability for the route, the encounter probability for the route may be determined as follows: All the probabilities for the route are added together and the resulting probability is used as the encounter probability for the route. In addition, the calculated encounter probability may be normalized to a value between 0 and 1. The following description will be made in the context of normalization of the encounter probability to between 0 and 1.

After computing the encounter probabilities for all the routes using the accumulated obstacle information 50, the path planning device 34 selects the route with the lowest encounter probability as an optimum route (S110). In this case, if a moving or movable obstacle is currently present on the route, the obstacle probability for the route is computed as a maximum value, or 1. For example, it is assumed that three routes, namely, route 1, route 2, and route 3, are acquired in S108 and the following encounter probabilities are obtained for the respective routes:

0.9 for the route 1,

0.5 for the route 2, and

0 for the route 3.

In this case, the route 3 is the route with the lowest encounter probability. Thus, the path planning device 34 selects the route 3. In contrast, if the non-contact obstacle detection device 40 detects a moving or movable obstacle at any grid on the route 3 or a sensor installed at a certain position in the cafe 10 detects a moving or movable obstacle at any grid on the route 3, the encounter probability for the route 3 is 1. Since the route 2 is the route with the lowest encounter probability, the path planning device 34 selects the route 2.

In this way, since the process according to this exemplary embodiment uses the relative magnitudes of encounter probabilities, the absolute values of the encounter probabilities are not of essence. In this sense, it is to be understood that the encounter probabilities may not necessarily be between 0 and 1. If the encounter probabilities are not normalized to between 0 and 1, if a moving or movable obstacle is currently present on a route, it goes without saying that the obstacle probability for the route is set to a certain maximum value instead of being set to 1.

If there are multiple routes with the lowest encounter probability, the path planning device 34 selects the route with the shortest path length to the goal as an optimum path (S111). For example, the following encounter probabilities are obtained:

0.5 for the route 1

0.5 for the route 2

1 for the route 3

The route 1 and the route 2 are routes with the lowest encounter probability. In this case, if the path length to the goal are

10 m for route 1 and

20 m for route 2,

then, the route 1 is selected as an optimum route.

After selecting a route, the path planning device 34 outputs a movement start instruction to the travel control device 36 (S112). In accordance with the instruction, the travel control device 36 outputs a control signal to the actuator 44 so that the self-propelled image forming apparatus 12 may move along the selected route. If the contact obstacle detection device 42 detects an obstacle while the self-propelled image forming apparatus 12 is moving along the route, the travel control device 36 executes specific processing such as causing the self-propelled image forming apparatus 12 to stop moving and to wait for a certain amount of time or warning the obstacle with a message to move off the route. When the self-propelled image forming apparatus 12 reaches the goal, the travel control device 36 causes the self-propelled image forming apparatus 12 to stop moving, and outputs a signal to an image forming unit (not illustrated) to notify that the self-propelled image forming apparatus 12 has reached the goal.

In S111, the encounter probability for the route on which a moving obstacle has currently been detected is 1. However, as described above, encounter probabilities may be changed in accordance with the position of the grid at which a moving obstacle is currently present. An encounter probability may be set higher for a shorter distance to the moving obstacle, and the route with the lowest encounter probability may be selected. In summary, a route on which a non-stationary obstacle has previously been present may be assigned a lower selection priority than a route which is otherwise, and a route on which a non-stationary obstacle is currently present may be assigned a lower selection priority than a route on which a non-stationary obstacle has previously been present. Alternatively, a route on which a non-stationary obstacle is currently present may be assigned a selection priority in accordance with the distance to the non-stationary obstacle in such a manner that a lower selection priority is placed to a route with a shorter distance. Thus, a route on which a non-stationary obstacle has not previously been present may be preferentially selected, and a route on which a non-stationary obstacle has been previously present would be preferentially selected over a route on which a non-stationary obstacle is currently present.

### Other Exemplary Embodiments

In the foregoing exemplary embodiment, the self-propelled image forming apparatus 12 finds paths to the goal point G when it is at the start point S, selects an optimum path, and moves along the selected path. In a certain situation, a moving obstacle may suddenly appear on the selected optimum path along which the self-propelled image forming apparatus 12 is moving to the goal. In an exemplary embodiment, processing for this situation will be described.

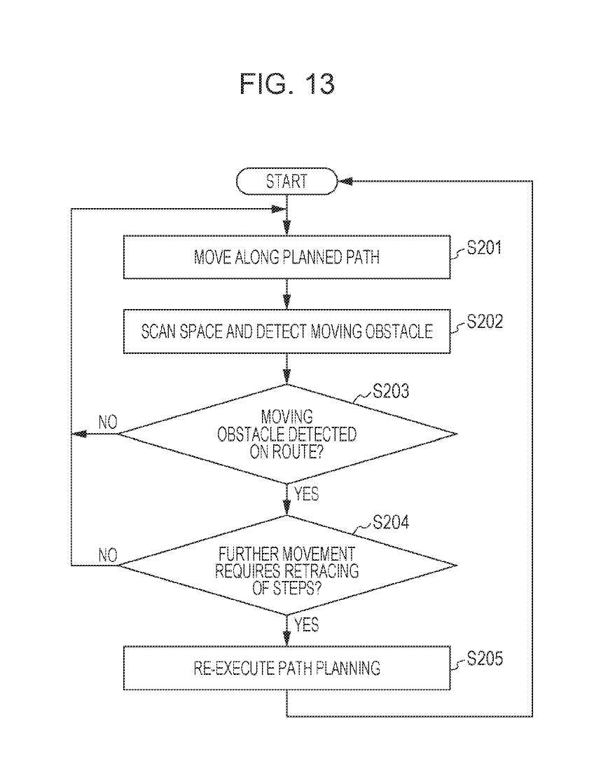

FIG. 13 is a flowchart illustrating a process according to this exemplary embodiment. First, the path planning device 34 and the travel control device 36 cause the self-propelled image forming apparatus 12 to move along a selected planned path (S201). The planned path is a path selected in accordance with the flowchart illustrated in FIG. 12.

Then, the non-contact obstacle detection device 40 scans over the route and detects a moving obstacle (S202). This processing may be executed using a sensor installed at a certain position in the cafe 10. Then, it is determined whether any moving obstacle has been detected on the route (S203).

If no moving obstacle is present on the route along which the self-propelled image forming apparatus 12 is moving (NO in S203), the self-propelled image forming apparatus 12 continues moving.

If a moving obstacle is detected on the route along which the self-propelled image forming apparatus 12 is moving (YES in S203), the path planning device 34 determines whether retracing of steps will be required if the self-propelled image forming apparatus 12 is to move ahead of its current position on the route (S204). This determination is based on the layout of stationary obstacles in the map layout N, which has been used to find the route.

If it is determined that retracing of steps is not required (NO in S204), the self-propelled image forming apparatus 12 continues moving.

If it is determined that retracing of steps is required, at the time when it is determined that retracing of steps is required, the path planning device 34 reroutes a new path from the current position serving as a new start point to the goal in accordance with the flowchart illustrated in FIG. 12 (S205).

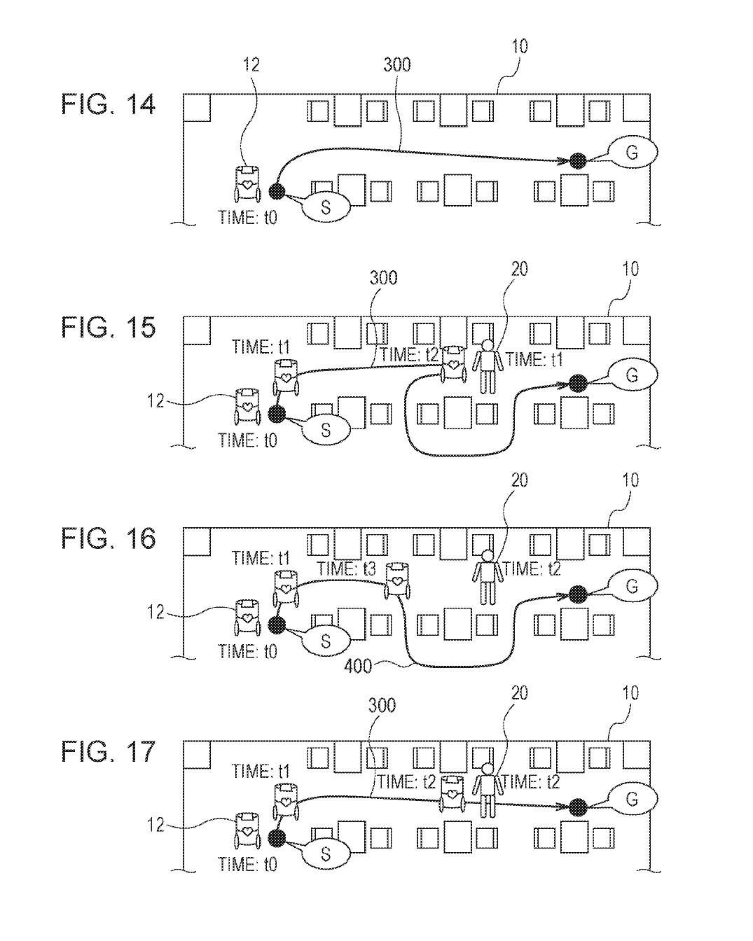

The process according to this exemplary embodiment will be described in more detail with reference to FIGS. 14 to 16.

FIG. 14 illustrates the situation at the time when the path planning device 34 selects a path to reach the goal in accordance with the flowchart illustrated in FIG. 12. The self-propelled image forming apparatus 12 is located at the start point S, and a path 300 is illustrated as a path to reach the goal point G. The illustrated situation is obtained at time t0.

FIG. 15 illustrates the situation at time t1 ahead of the time t0. At the time t1, the self-propelled image forming apparatus 12 moves to a certain position along the path 300. At this time, it is assumed that a moving obstacle 20 has been detected on the path 300. In this case, a rerouting process for uniformly rerouting a path upon detecting a new moving obstacle 20 on the path 300 would be inefficient because the self-propelled image forming apparatus 12 finds a new path each time a moving obstacle 20 is detected and moves along the found path, which may ultimately result in much time being taken to reach the goal.

Accordingly, even if a moving obstacle 20 suddenly appears on the path 300 along which the self-propelled image forming apparatus 12 is moving, the self-propelled image forming apparatus 12 will continue moving along the path 300 until there is no option but to retrace its steps. As illustrated in FIG. 15, the self-propelled image forming apparatus 12 continues moving along the path 300 and, at time t2, has no option but to retrace its steps. At this time, the self-propelled image forming apparatus 12 eventually needs to reroute a path and retrace the path along which it has come.

In contrast, as illustrated in FIG. 16, the self-propelled image forming apparatus 12 moves to a position at which the self-propelled image forming apparatus 12 will have no option but to retrace the path along which it has come if it is to move ahead. That is, the self-propelled image forming apparatus 12 moves to the above-described position at time t3. At the time t3, the self-propelled image forming apparatus 12 reroutes a path that it may take to reach the goal point G. In this case, the self-propelled image forming apparatus 12 does not retrace the path along which it has come, and the arrival time will be shortened accordingly. In FIG. 16, a path 400 is obtained as a result of rerouting. Since the encounter probability for the path 300 on which the moving obstacle 20 is present is set to 1 when a path is rerouted, the path 300 is not selected as an optimum path in the rerouting process. Comparing the path 300 illustrated in FIG. 15 with the path 400 illustrated in FIG. 16 will make it clear that the path 400 has superiority over the path 300.

In this exemplary embodiment, if the self-propelled image forming apparatus 12 is at a position where there is no option but to retrace its steps at the time when the moving obstacle 20 is detected, a message may be sent to warn the moving obstacle 20 to move off the path.

FIG. 17 illustrates the above situation. The self-propelled image forming apparatus 12 moves along the path 300, and a moving obstacle 20 is detected at time t2. However, there is no detour around the moving obstacle 20 at this time, and therefore the self-propelled image forming apparatus 12 has no option but to retrace the path along which it has come. Then, the path planning device 34 outputs a message such as “please move a little off the way” from the user interface 38.

While some exemplary embodiments of the present invention have been described, the present invention is not limited to these exemplary embodiments, and a variety of modifications may be made.

For example, in the illustrated exemplary embodiments, the self-propelled image forming apparatus 12 is exemplified as a self-propelled working apparatus. However, in one exemplary embodiment, a self-propelled working apparatus configured to do any work other than forming an image may be used. Furthermore, the self-propelled working apparatus may not necessarily be of a vehicle type, and may be widely applicable to general robots. In other words, the self-propelled working apparatus may be a self-propelled robot.

In FIG. 17, a message is sent to warn the moving obstacle 20 (which will be a person in many cases) to move off the path. Since the path planning device 34 has the map information 52 and information of the planned path, the path planning device 34 may request the moving obstacle 20 to move to a certain place based on the map information 52 and the information of the planned path. For example, if there is a stationary obstacle to the left of the moving obstacle 20 when viewed from the self-propelled image forming apparatus 12 and there is a space to the right thereof which is off the route, a message such as “please move a little to the right” may be output from the user interface 38. Alternatively, the user interface 38 may be formed of a liquid crystal screen or the like, and the goal point G may be displayed on the screen to clearly notify the moving obstacle 20 of where the self-propelled image forming apparatus 12 is going to move. It will be a matter of course that the self-propelled image forming apparatus 12 waits for a certain amount of time (for example, 30 seconds) and sends a message after confirming the state of the moving obstacle 20. During the waiting period, a message indicating waiting for the moving obstacle 20 to move off the way may be displayed on the user interface 38.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A path finding device comprising:
a search unit that finds paths to reach a goal point from a start point while detouring around a stationary obstacle;
a calculation unit that calculates, for each of the found paths, an encounter probability that is a probability of encountering a non-stationary obstacle using previously accumulated non-stationary obstacle information; and
a selection unit that selects a path with a lowest encounter probability among the found paths.

2. The path finding device according to claim 1, wherein the selection unit selects a path with a shortest path length from the start point to the goal point in a case where the found paths include a plurality of paths with the lowest encounter probability.

3. The path finding device according to claim 1, further comprising a detection unit that detects a non-stationary obstacle, wherein
the calculation unit calculates the encounter probability for a path on which a non-stationary obstacle is currently detected by the detection unit as 1.

4. The path finding device according to claim 1, further comprising a detection unit that detects a non-stationary obstacle, wherein
the calculation unit calculates the encounter probability for a path on which a non-stationary obstacle is currently detected by the detection unit in such a manner that the encounter probability for a path with a shorter distance to the non-stationary obstacle is higher.

5. The path finding device according to claim 1, further comprising:
a detection unit that detects a non-stationary obstacle; and
a rerouting unit that reroutes a path,
wherein in a case where a non-stationary obstacle is detected on a selected path during movement along the selected path, the rerouting unit determines whether further movement toward the goal point along the selected path requires retracing of steps, and reroutes a path to reach the goal point at the time when it is determined that retracing of steps is required.

6. The path finding device according to claim 1, wherein
a movable area including the start point and the goal point is divided into a plurality of grids, each of the plurality of grids being assigned the non-stationary obstacle information, and
the calculation unit calculates the encounter probability using the non-stationary obstacle information assigned to grids of each of the found paths.

7. A self-propelled working apparatus comprising:
the finding device according to claim 1; and
a travel control device that causes the self-propelled working apparatus to move to the goal point along a selected path.

8. A path finding device comprising:
a determination unit that determines paths from a start point to a destination point in accordance with stationary obstacle information;
a calculation unit that calculates, for each of the paths determined by the determination unit, a probability of encountering a non-stationary obstacle using non-stationary obstacle information, the non-stationary obstacle information including previous records of appearance of a non-stationary obstacle; and
a selection unit that selects a path with a lowest probability of encountering a non-stationary obstacle calculated by the calculation unit.

9. A non-transitory computer readable medium storing a program causing a computer to execute a process, the process comprising:
finding paths to reach a goal point from a start point while detouring around a stationary obstacle;
calculating, for each of the found paths, an encounter probability that is a probability of encountering a non-stationary obstacle using previously accumulated non-stationary obstacle information; and
selecting a path with a lowest encounter probability among the found paths.
